(19) United States
(12) Patent Application Publication
(10) Pub. No.: US 2003/0227881 A1
(43) Pub. Date: Dec. 11, 2003

(54) Apparatus, and associated method, for facilitating delivery of signaling data in a packet radio communication system

(76) Inventors: Liangchi Hsu, San Diego, CA (US); Mark W. Cheng, San Diego, CA (US)

Correspondence Address: Robert H. Kelly, Scheef & Stone, LLP, Suite 1400, 5956 Sherry Lane, Dallas, TX, 75225, US

(21) Appl. No.: 10/370,041

(22) Filed: Feb. 19, 2003

Related U.S. Application Data
(60) Provisional application No. 60/357,760, filed on Feb. 19, 2002.

(51) Int. Cl. H04Q 7/00; H04J 3/24

(52) U.S. Cl. 370/329; 370/349; 370/474

(57) ABSTRACT

Apparatus, and an associated method, for facilitating communication of a data signaling message on an F-PDCH in a CDMA 2000 1×EV-DV communication system. Determination is made as to whether the data signaling message is of a length shorter than the bit-length allocation of a frame within which to communicate the data signaling message. If so, copies of the data signaling message are formed and interleaved by an interleaver to form interleaved representations thereof. The interleaved copies are inserted into the available portions of the frame and communicated upon the F-PDCH. Increased reliability of transmission due to the increased redundancy at reduced susceptibility to burst error is provided.

### CROSS-REFERENCE TO RELATED APPLICATIONS

The Present application claims the priority of provisional patent application No. 60/357,760, filed on 19 Feb. 2002.

The present invention relates generally to a manner by which to communicate variably-sized, packet-formatted signaling data messages, on a high-speed packet channel in a radio communication system, such as a cellular radio communication system constructed pursuant to a cdma 2000 standard that provides for 1×EV-DV data communications. More particularly, the present invention relates to apparatus, and an associated method, by which to facilitate communication of a signaling data message in a spectrally-efficient, and reliable, manner.

At least a portion of the signaling data message that is to be communicated is copied, interleaved and, once interleaved, transmitted. The transmission of the interleaved message is carried out.within an allocated frame of a selected frame length.

Improved reliability of communication of the signaling data message is provided without necessitating allocation of additional communication resources for the retransmission of the message.

### BACKGROUND OF THE INVENTION

Use of communication systems through which to communicate data between two, or more, locations is an endemic part of modern society. Communication stations are positioned at the separate locations and operate to effectuate the communication of the data.

In a minimal implementation, the communication system is formed of a first communication station, forming a sending station, and a second communication station, forming a receiving station. A communication channel interconnects the communication stations. Data that is to be communicated by the first communication station to the second communication station is converted, if necessary, into a form to permit its communication upon the communication channel. And, the second communication station operates to detect the data communicated thereto by the first communication station and to recover the informational content thereof.

In a radio communication system, the communication channel that interconnects the sending and receiving stations is formed of a radio channel, defined upon a radio link, formed upon the electromagnetic spectrum. Other, conventional communication systems generally require a fixed, wireline connection extending between the communication stations upon which to define communication channels.

As a radio link, rather than a wireline connection, is utilized upon which to define the communication channels, the need otherwise to utilize wireline connections upon which to define the communication channels is obviated. As a result, installation of the infrastructure of the radio communication system is generally less costly than the corresponding costs that would be required to construct a conventional, wireline communication system. And, mobility of the communication station can be provided, thereby to permit a radio communication system to form a mobile radio communication system.

A cellular communication system is an exemplary type of radio communication system. Cellular communication systems have been widely implemented and have achieved wide levels of usage. A cellular communication system provides for radio communications with mobile stations. The mobile stations permit telephonic communication to be effectuated therethrough. And, mobile stations are generally of sizes to permit their carriage by users of the mobile stations.

A cellular communication system includes a network part that is installed throughout a geographical area and with which the mobile stations communicate by way of radio channels defined upon radio links allocated to the communication system.

Base transceiver stations, forming portions of the network part of the communication system, are installed at spaced-apart locations throughout the geographical area that is to be encompassed by the communication system. Each of the base transceiver stations defines a cell, formed of a portion of the geographical area. And, the term cellular is derived from the cells defined by the base transceiver stations.

When a mobile station is within the cell defined by a base transceiver station, communications are generally effectuable with the base transceiver station that defines the cell. As a mobile station travels between the cells defined by different ones of the base transceiver stations, communication handoffs are effectuated to permit continued communications by, and with, the mobile station. Through appropriate positioning of the base transceiver stations, the mobile station, wherever positioned within the geographical area encompassed by the cellular communication system, shall be within close proximity of at least one base transceiver station. Therefore, only relatively low-powered signals need to be generated to effectuate communications between a mobile station and a base transceiver station. Hand-offs of communications between successive base transceiver stations, as the mobile station moves between cells, permit the continued communications without necessitating increase in the power levels at which the communication signals are transmitted. And, the low-power nature of the signals that are generated permit the same radio channels to be reused at different locations of the cellular communication system. Efficient utilization of the frequency-spectrum allocation to the cellular communication system is thereby possible.

Cellular, as well as various other, communication systems are constructed to be operable pursuant to an appropriate operating specification. Successive generations of operating specifications have been promulgated. And, corresponding generations of cellular communication networks have been installed throughout wide areas to permit telephonic communications therethrough. So-called first-generation and second-generation cellular communication networks have been widely implemented and have achieved significant levels of usage. And, installation of so-called third-generation and successor-generation systems have been proposed. An exemplary operating specification, referred to as the CDMA 2000 specification, sets forth the operating parameters of an exemplary, third-generation communication system. The CDMA 2000 specification is being promulgated by the 3GPP2 (Third Generation Partnership Project).

The CDMA 2000 operating specification, as well as other third-generation operating specifications, provide for packet-based data communication services. The CDMA 2000 operating specification provides for high data rate communication services to be effectuated therethrough. Amongst the communication services that shall be available are multicast and broadcast services (MBS) in which data sourced at a data source connected, or otherwise coupled, to the network infrastructure of the communication system is communicated to permit its detection and viewing at one or more mobile stations.

Proposals for inclusion in the operating specification for the aforementioned CDMA 2000 communication system, for instance, include various technology proposals by which to effectuate the communication of data at high data rates. One general category of proposal is referred to as the 1×EV-DV technology. In such a proposal, a 1×EV-DV, high-speed data channel is defined upon which to communicate packet-formatted data, sometimes referred to as 1×EV-DV data, at high data rates. The high-speed data channel upon which forward-link data is to be communicated is defined to be a F-PDCH (Forward-Packet Data Channel).

In the proposed system, the F-PDCH is utilized for two separate purposes. First, the channel is to be utilized upon which to communicate high-speed packet user data. And, secondly, the channel is to be utilized upon which to communicate CDMA 2000 signaling messages. The usage of the channel upon which to communicate the high-speed packet user data is the originally-defined usage of the channel. And, the usage of the channel upon which to communicate the signaling messages is an enhancement to the signaling mechanism in a CDMA2000 system in which, otherwise, only a F-FCH (Forward-Fast Control Channel) and a F-DCCH (Forward-Digital Control Channel) is used to communicate, on the forward link, signaling messages. These others channels, i.e., the F-FCH and the F-DCCH are referred to as “fundicated” channels.

The 1×EV-DV F-PDCH (forward packet data channel) provides for high-speed data rates and utilizes a relatively large-sized physical layer frame length of, between 384 and 3840 bits. But, use of a frame of this relatively large length is susceptible to spectrum inefficiency. That is to say, unnecessary spectral “waste” occurs if the signaling message is of a length shorter than 384 bits. A significant percentage of the signaling data messages at the physical layer are substantially shorter than 384 bits.

A proposal has been set forth to repeat transmission of the signaling data message within the frame if space is available within the frame to retransmit the message. In the proposal, the message body, together with its associated CRC (cyclic redundancy code), is repeated to fill up the otherwise wasted portion of the F-PDCH physical layer frame.

But, the existing proposal exhibits various drawbacks. If there is a repeated message and its associated CRC, burst errors occurring to one of the messages might also occur to the repeated message. The advantage of the redundant transmission would, in such an occurrence, be defeated. Also, if space is available for a partial repetition of a message, i.e., only part of the message can be retransmitted, the final portion of the message, at which the CRC is positioned, would not be included in the retransmitted message. The CRC is an essential portion of the transmitted information.

It is in light of this background information related to communication of data signaling messages in a radio communication system that the significant improvements of the present invention have evolved.

### SUMMARY OF THE INVENTION

The present invention, accordingly, advantageously provides apparatus, and an associated method, by which to facilitate communication of a signaling data message in a spectrally-efficient, and reliable, manner.

Through operation of an embodiment of the present invention, a manner is provided by which to communicate variably-sized, packet-formatted signaling data messages, on a high-speed packet channel in a radio communication system, such as a cellular radio communication system constructed pursuant to a cdma 2000 standard that provides for 1×EV-DV data communications.

In one aspect of the present invention, at least a portion of the signaling data message that is to be communicated is interleaved and, once interleaved, its transmission is repeated. The retransmission of the interleaved message is carried out within an allocated frame of a selected frame length. Improved reliability of communication of the signaling data message is provided without necessitating allocation of additional communication resources for the retransmission of the message.

When a CDMA 2000 1×EV-DV high-speed data channel, i.e., the F-PDCH (Forward-Packet Data Control Channel), is used to deliver signaling messages, if the signaling messages are of short lengths, the bit-space allocated in the channel for their transmission is not completely utilized.

The available bit-space is utilized pursuant to an embodiment of the present invention. The reliability of the transmitted message is increased by increasing its redundancy while also lessening problems that might result in the event of burst errors, such as errors caused as a result of fading conditions.

If the bit-space remains to permit a fully-repeated message, together with its associated CRC, to be retransmitted, the fully-repeated message, and its CRC are interleaved together. And, the resultant interleaved values are sent within the frame defined of the F-PDCH.

If the bit-space that remains permits a multiple number of fully-repeated messages, together with their associated CRCs to be retransmitted, the fully-repeated messages and their associated CRCs are interleaved together. And, the resultant, interleaved values are sent within the frame defined of the F-PDCH.

If bit space remains to permit part of a message to be retransmitted, the CRC associated with the message is placed in a position, i.e., at the front of the retransmission-portion, thereby to ensure its communication within the frame defined of the F-PDCH.

Interleaving is performed in any of various manners. In one manner, for each repeated message, the message is interleaved with the same interleaving length. In another manner, different ones of the repeated messages are interleaved with different interleaving lengths. And, in another manner, all of the repeated messages are commonly interleaved. In this third manner, higher reliability is provided, albeit at increased, subsequent interleaving delay.

In these and other aspects, therefore, apparatus, and an associated method, is provided for a mobile communication system. The mobile communication system has network infrastructure and a mobile station. And, the mobile communication system defines a packet data channel. Efficient usage of the packet data channel upon which to communicate short-length message data together with a CRC part to a mobile station is facilitated. A concatenator concatenates at least a portion of the short-length message data together with the CRC part to form a repeated message. And, an interleaver selectably interleaves the repeated message. Thereafter, the repeated message, once selectably interleaved, is available for transmission.

A more complete appreciation of the present invention and the scope thereof can be obtained from the accompanying drawings that are briefly summarized below, the following detailed description of the presently preferred embodiments of the invention, and the appended claims.

### BRIEF DESCRIPTION OF THE DRAWINGS

FIG. 1 illustrates a functional block diagram of an exemplary radio communication system in which an embodiment of the present invention is operable.

FIG. 2 illustrates a representation of the format of a F-PDCH (Forward-Packet Data Channel) within which signaling data messages are communicated during operation of the radio communication system shown in FIG. 1.

FIG. 3 illustrates a representation of an exemplary, message formed pursuant to operation of an embodiment of the present invention.

FIG. 4 illustrates a representation of an exemplary, message, analogous to that shown in FIG. 3, also formed pursuant to operation of an embodiment of the present invention.

FIG. 5 also illustrates a representation, similar to those shown in FIGS. 2-4, of an exemplary message also formed pursuant to operation of an embodiment of the present invention.

FIG. 6 also illustrations a representation, similar to those shown in FIGS. 2-5, of another exemplary message formed pursuant to operation of an embodiment of the present invention.

FIG. 7 also illustrates a representation, similar to those shown in FIGS. 2-6, of another exemplary message formed pursuant to operation of an embodiment of the present invention.

### DETAILED DESCRIPTION

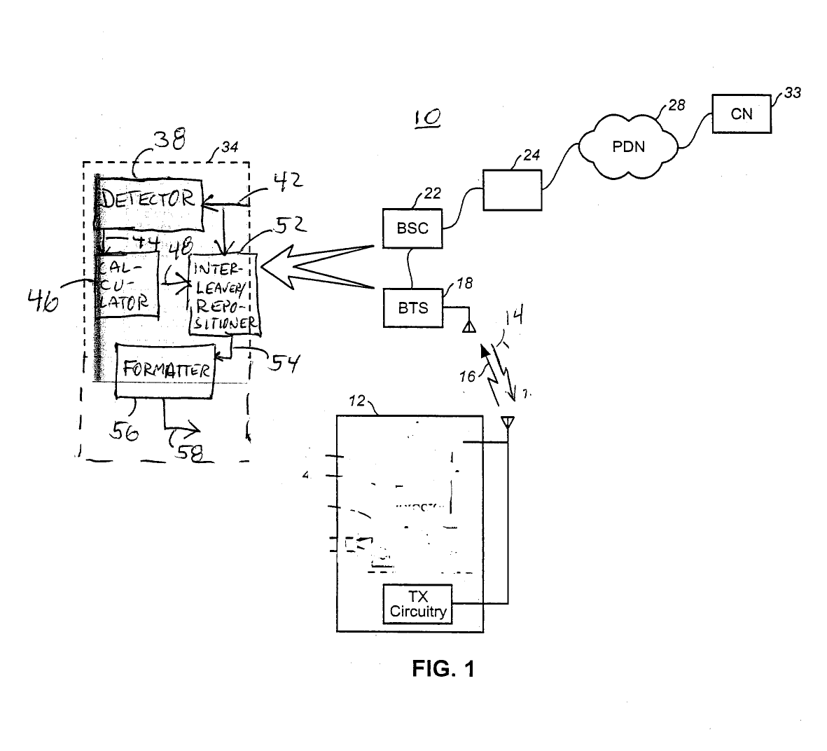

Referring first to FIG. 1, a radio communication system, shown generally at 10, provides for radio communications with mobile stations, of which a single mobile station 12 is shown in the figure. In the exemplary implementation, the communication system forms a cellular communication system operable, generally, pursuant to a CDMA 2000, cellular operational specification that provides for 1×EV-DV data communications.

The teachings of the present invention are, however, also implementable in any of various other types of communication systems in which digital signaling messages are sent. Accordingly, while the following description shall describe operation of an embodiment of the present invention with respect to its implementation in a CDMA 2000 communication system that provides for 1×EV-DV data communications, the present invention is analogously also operable in other types of communication systems.

The mobile station 12 communicates by way of radio links with a network part of the communication system. The radio links are represented here by a forward link 14 and reverse links 16. Radio channels are defined upon the forward and reverse links. And, of particular significance to operation of an embodiment of the present invention, a 1×EV-DV F-PDCH (Forward-Packet Data Control Channel) is defined upon the forward link. Additional channels are defined upon both the forward and reverse links, details of which are set forth more fully in the CDMA 2000 standard. And, cellular, and other, communication systems define analogous such channels.

A network part of the communication system includes a base transceiver station (BTS) 18. Both the base transceiver station and the mobile station form radio transceivers capable of transducing radio signals therebetween by way of radio channels defined upon the forward and reverse links 14 and 16. The base transceiver station forms part of a radio access network portion of the network part of the communication system. And, the radio access network part of the communication system is here shown further to include a base station controller (BSC) 22 and point control function (PCF) and a packet data service node (PDSN) 24. The BSC is coupled between the base transceiver station and the PDSN.

The PDSN forms a gateway with a fixed-network part, here represented by a packet data network (PDN) 28. A correspondent node (CN) 33 is coupled to the network 28 and is representative of a communication node with which communications are effectuable with the mobile stations 12. The correspondent node is formed, for example, of a content server at which data that is to be sent to the mobile station is sourced.

The network part of the communication system includes apparatus 34 of an embodiment of the present invention. The apparatus is implemented at any desired location of the network part, such as, here, at the base station controller or base transceiver station, or distributed therebetween. The elements that form the apparatus are functionally represented and can be implemented in any desired manner, such as by algorithms executable by processing circuitry.

The apparatus 34 includes a detector 38 that is coupled to receive, here indicated by the line 42, data signaling messages that are to be sent upon the F-PDCH. The detector, upon detection of a signaling data message, determines the bit-length of the message. That is to say, the detector 38 further counts the number of bits of which the data signaling message is formed. The data signaling message is of any of many bit-lengths. However, as indicated previously, a significant number of the messages that are to be communicated upon the F-PDCH during operation of the communication system are of bit-lengths significantly shorter than the number of bits allocated in a frame of the F-PDCH within which to communicate such messages.

The detector generates values, here indicated to be formed upon the line 44 that extends to a calculator 46. The calculator 46 operates to calculate whether the data signaling message, together with a CRC (cyclic redundancy code) associated therewith can be retransmitted within the portion of the frame defined upon the F-PDCH within which the data signaling messages are to be communicated. The calculator knows of the bit length of the allocated portion of the frame of the F-PDCH.

Calculations made by the calculator are provided, here indicated by way of the line 48, to an interleaver and repositioner 52. The interleaver and repositioner also is coupled to receive the data signaling messages provided to the apparatus by way of the line 42. The interleaver and repositioner is selectably operable, as shall be noted more fully hereinbelow, to interleave two, or more, copies of a data signaling message together with their associated CRC codes. The number of copies of the data signaling message, and associated CRC code, that is interleaved by the interleaver is dependent upon calculations made by the calculator 46.

The interleaver and repositioner is also selectably operable to reposition a data signaling message and CRC associated therewith. That is to say, a CRC is typically concatenated to a data signaling message. When the interleaver and repositioner operates to reposition values, repositioning of the CRC relative to its associated data signaling message is effectuated. That is to say, the repositioning positions the CRC code associated with a data signaling message in front thereof instead of concatenated thereto.

Once the data signaling message, its associated CRC code, a copy of the message, or a portion therof, and its associated CRC code is formed, the values of such are provided, here indicated by way of the line 54 to a formatter 56. The formatter 56 operates to insert the values provided thereto into the frame defined upon the F-PDCH. The values, formatted into the frame are generated on the line 58, thereafter to be communicated upon the F-PDCH base the base transeiver station to the mobile station.

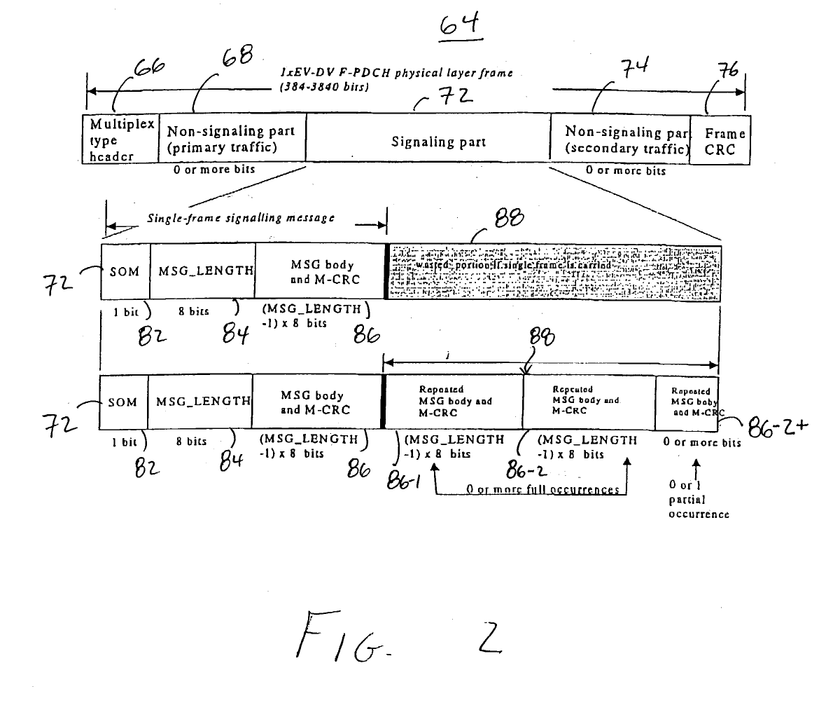

FIG. 2 illustrates the format of an exemplary F-PDCH physical layer frame defined pursuant to the CDMA 2000 specification that provides for 1×EV-DV data communications. The frame is shown generally at 64. The frame is of a variable bit-length, between 384 and 3840 bits. The frame is formatted to include a multiplex type header field 66 and non-signaling part 68, used for primary traffic communications. The field 68 is of zero or bits, depending upon whether primary traffic data, i.e., high-speed data, is to be communicated within the frame. The frame further includes a signaling part 72, another non-signaling part 74 within which secondary traffic data is communicated, if appropriate, and a frame CRC field 76.

Data signaling messages are populated, pursuant to operation of an embodiment of the present invention, in the signaling part 72 for communication by the network part of the communication system to a mobile station, such as the mobile station 12.

The Figure also illustrates an expansion of the signaling part 72. The signaling part 72 is shown to be formed of a single-bit, SOM field 82, a message length (MSG_LENGTH) field 84 of an eight-bit length, and a message (MSG) body and CRC (M-CRC) portion 86. If the collective lengths of the portions 82, 84, and 86 are less than the bit-length allocated to the signaling part 72, the remaining portion, here indicated at 88, remains. If data is not communicated in this portion, its availability would be wasted.

The bottom portion, as-shown, of the Figure also again illustrates the signaling part 72 in which the portion 88 is used within which to repeat transmission of data signaling messages populated in the portion 86, thereby to make use of the otherwise wasted portion of the signaling part. Here, in an exemplary scenario, the data signaling message, together with its associated CRC is repeated to and a fraction number of times in the portion 88. The repeated portions are indicated at 86-1, 86-2 and 86-2+.

Mere insertion of the repeated signaling data signaling message and associated CRC values leaves such values susceptible to burst errors, caused, for instance, by fading conditions on the F-PDCH during transmission of the message or copy thereof.

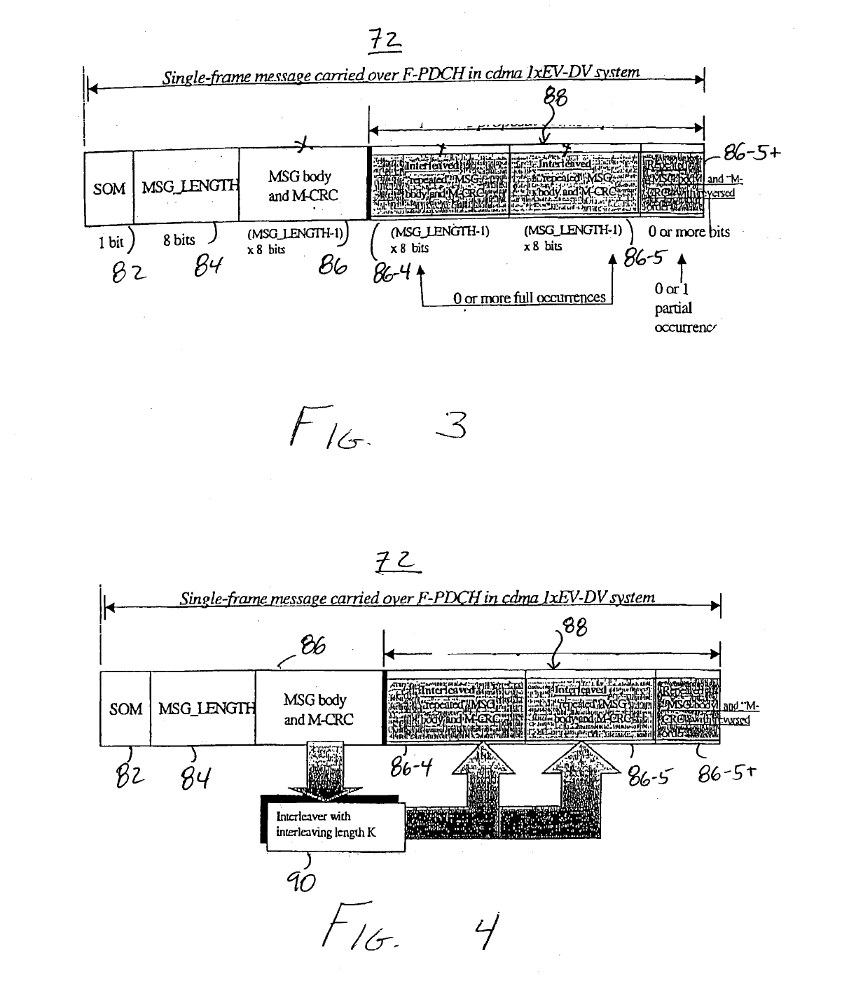

FIG. 3 illustrates the signaling part 72 formed pursuant to operation of the apparatus 34 of an embodiment of the present invention. The apparatus 34, as noted previously, operates, amongst other things, selectably to interleave the fully-repeated messages and their associated CRC values. Through interleaving of the repeated messages and their CRC values, the effect of data loss is dispersed. Any burst loss on each repeated message is transformed into a sequence of isolated losses through operation of the interleaving.

The signaling part 72 shown in the Figure again is shown to include the SOM field 82, a message length field 84, and the message body and message-CRC field 86. Here, however, the portion 88 includes interleaved copies of the data signaling message and associated CRC values. The interleaved copies are here indicated at 86-4, 86-5 and 86-5+.

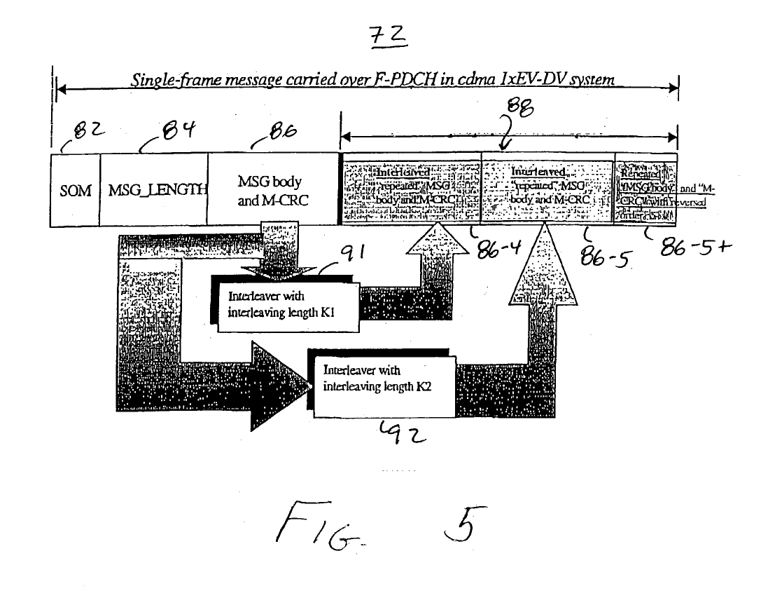

Any of various interleaving approaches can be utilized. FIG. 4 illustrates the portion 88 shown in FIG. 3, here again with copies 86-4, 86-5, and 86-5+. In the interleaving scheme that is utilized to form the parts 86-4 and 86-5 in FIG. 4, the same interleaving, with the same interleaving lengths K are applied, indicated by the block 90, to all repeated blocks.

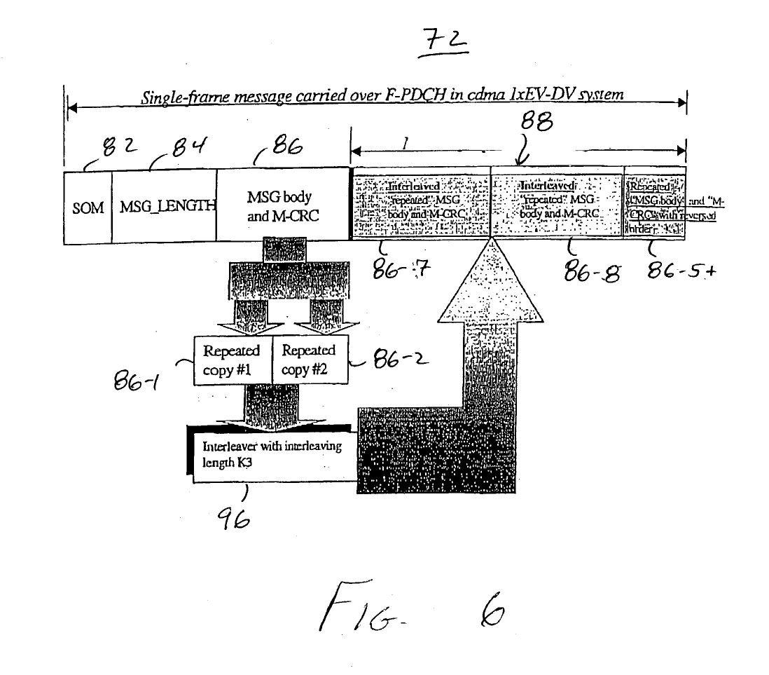

FIG. 5 illustrates the signaling part 72 formed pursuant to an alternate interleaving approach. Again, the signaling part includes an SOM field 82, a message length field 84, and a message body and message-CRC field 86. In this interleaving approach, variable interleaving lengths, K1 and K2, are used during interleaving, indicated by the block 91 and 92, to form the separate interleaved copies, again shown at 86-4 and 86-5. The part 86-5+ of the copy of the data signaling message is not interleaved.

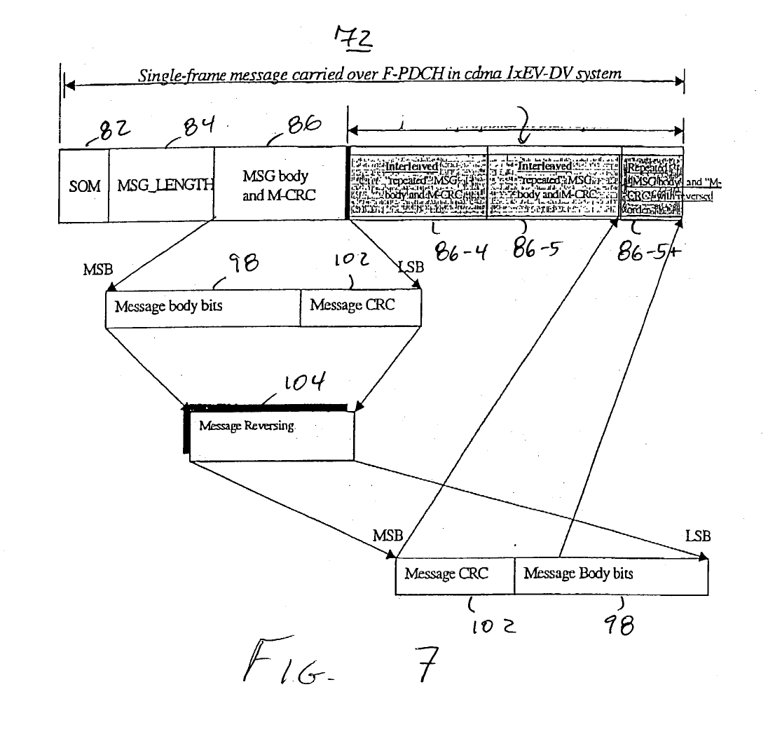

FIG. 6 illustrates the signaling part 72 formed as a result of use of an interleaving approach of another embodiment of the present invention. The signaling part 72 is again shown to be formed of an SOM field 82, message length field 84, and a message body, together with CRC values part 86. In this interleaving approach, a single interleaver combines and interleaves all repeated blocks, here two copies, 86-1 and 86-2, at once. Interleaving, with an interleaving length K3, indicated by the block 96 is performed to form the interleaved values, indicated by the blocks 86-7 and 86-8. Again, the portion of the repeated block 86-5+ is not interleaved in the exemplary implementation.

Due to the relative significance of the values of the CRC associated with a data signaling message, or copy thereof, operation of a further embodiment of the present invention repositions the relative location of the CRC values relative to its associated message copy. When only a portion of the data signaling message and associated CRC values can be placed in the part 88 or remaining bit locations thereof, the CRC values are removed from their position in concatenation with the data signaling message copy and placed at the front thereof. Thereby, the CRC bits are always available for transmission. That is to say, if there are remaining bits left over for a partial message repetition, after fully repeating message insertion, the CRC is repeated first.

FIG. 7 illustrates the operation of this further embodiment of the present invention. The signaling part 72 again includes the portions 82, 84, and 86. And, here, for purposes of illustration, two interleaved copies 86-4 and 86-5 are placed in the portion 88 of the signaling part.

The data signaling message and its associated CRC values are also represented in expanded form, designated at 98 and 102, respectively. Here, repositioning, namely, message reversing, is performed, indicated by the block 104 to reverse the relative positions of the CRC values and the data signaling message values. Once repositioned, to the extent possible, the repositioned CRC values and message body bits are inserted into the portion 88, again shown 86-5+.

Thereby, the available space in the signaling part of the F-PDCH frame is fully utilized to increase the redundancy of the signaling data message in a manner that is less prone to burst error. Improved communications in the communication system are possible as the data signaling messages are transmitted in a redundant manner, and interleaved so as to reduce the possibility that the informational content of the data signaling message, or a copy thereof, shall be lost due to burst errors.

The previous descriptions are of preferred examples for implementing the invention, and the scope of the invention should not necessarily be limited by this description. The scope of the present invention is defined by the following claims:

We claim:

1. In a mobile communication system having network infrastructure and a mobile station, the mobile communication system defining a packet data channel, an improvement of apparatus for facilitating efficient usage of the packet data channel upon which to communicate short-length message data together with a CRC part to the mobile station, said apparatus comprising:
a concatenator for concatenating at least a portion of the short-length message data together with the CRC part to the short-length message data part to form a repeated message; and
an interleaver for selectably interleaving the repeated message.

2. In a method of communicating in a mobile communication system having network infrastructure and a mobile station, the mobile communication system defining a packet data channel, an improvement of a method for facilitating efficient usage of the packet data channel upon which to communicate short-length message data together with a CRC part to the mobile station, said method comprising:
concatenating at least a portion of the short-length message data together with the CRC part to the short-length message data ppart to form a repeated message;
selectably interleaving the repeated message; and
transmitting the repeated message, once selectably interleaved.
